(19) United States
(12) Patent Application Publication
(10) Pub. No.: US 2025/0196952 A1
(43) Pub. Date: Jun. 19, 2025

(54) MASTER LINK AND HALF LINK FOR SAME CONFIGURED FOR STRESS DE-CONCENTRATION

(71) Applicant: Caterpillar Inc., Peoria, IL (US)

(72) Inventors: Jason L. Sebright, Chillicothe, IL (US); Eric B. Weisbruch, Edwards, IL (US); Donovan S. Clarke, East Peoria, IL (US); Kevin Steiner, Tremont, IL (US)

(73) Assignee: Caterpillar Inc., Peoria, IL (US)

(21) Appl. No.: 18/545,406

(22) Filed: Dec. 19, 2023

(51) Int. Cl. B62D 55/21

(52) U.S. Cl. CPC B62D 55/213

(57) ABSTRACT

A track link assembly for a ground-engaging track includes a plurality of track links in a track chain and having a master link with a first half link and a second half link. The first half link includes a first clamping surface having a first tooth set, and the second half link includes a second clamping surface having a second tooth set. The first clamping surface includes a link lateral width transition defining a first stress concentration location, and a slope gradient transition defining a second stress concentration location and spaced from the link lateral thickness transition. Separating curved transitions of the clamping surface limits overlapping and/or additive stresses to improve field service and breakage resistance of the master link.

### TECHNICAL FIELD

The present disclosure relates generally to a master link for a track, and more particularly to a half link in a master link having a clamping surface contoured for separating stress concentrations.

### BACKGROUND

Many off-highway machines have ground-engaging tracks including a plurality of links coupled together to form a flexible, endless loop that extends around rotatable track-engaging elements. Mining, construction, forestry, roadbuilding and other industries all rely to a great extent upon machines having ground-engaging tracks. As with any machine system, it can be desirable to provide some means for facile servicing or repair of components. A “master link” is provided in many ground-engaging tracks for this purpose. Many different designs have been developed over the years.

In one common style of master links multiple teeth are provided on separate master link portions or “half links” that can be interlocked to mate the master link portions together. Fasteners such as bolts may be used to secure the respective link portions together, and the master link installed in a track where it operates much like any of the other links. When it is desirable to break the track for repair, servicing, shipping, et cetera, the fasteners coupling the link portions together are removed, allowing the track to be separated via disassembling the master link. More than one master link can be used in a given track chain. Assembled tracks consisting of parallel track chains will typically have at least two master links. While the basic two-part master link design has proven to be quite useful, the ruggedness of many environments within which track-type machines operate can place a premium on durability and service life, and some existing master links tend to prematurely fail.

The number, spacing, orientation, curvature, and other geometric features of teeth in master links can vary, and engineers have experimented with numerous different designs over the years. It has also been discovered that in certain instances, a single-tooth design provides a practical strategy. Single-tooth master links, however, can nevertheless have disadvantages and in some instances appear to permit rotation or rocking between the link portions ultimately leading to performance degradation or failure.

Multi-tooth master link designs can have their own advantages and disadvantages. While the multiple teeth can assist in achieving a robust interlock between the link portions, extensive machining time during manufacturing can be required to produce the separate link portions with numerous teeth. Regardless of tooth number or other master link features, stress concentrations can result at various locations. Various known strategies employ bolt sizing and bolt hole location specifications that attempt to reduce the likelihood of stress concentrations or diffuse stresses more generally. United States Patent Application Publication No. 2008/0174175 to Livesay et al. is directed to a master link for a track including profiled surfaces of first and second link members having the form of a sinusoidal segment defined by a tooth and an adjacent recess. While Livesay et al. may have advantages in application, for the reasons discussed above and still others there is always room for improvement and alternative strategies in this field.

### SUMMARY

In one aspect, a master link for a track includes a first half link having a first link strap with a first inboard-outboard bore formed therein, a first clamping surface including a descending slope, an ascending slope extending to a vertically-facing link surface, and a first tooth set spaced fore-aft from the first inboard-outboard bore and arranged between the descending slope and the ascending slope. The ascending slope includes a width lateral thickness transition, and a slope gradient transition. The slope gradient transition is spaced fore-aft between the link lateral thickness transition and a center axis of the first inboard-outboard bore. The master link further includes a second half link including a second link strap having a second inboard-outboard bore formed therein, and a second clamping surface shaped complementary to the first clamping surface.

In another aspect, a half link for a master link includes a link body having a shoe-side surface and a rail surface opposite the shoe-side surface, a clamping surface extending vertically between the shoe-side surface and the rail surface and fore-aft between a link body end and a link strap having an inboard-outboard bore formed therein. The clamping surface includes a descending slope, an ascending slope, and a tooth set arranged between the descending slope and the ascending slope. The ascending slope has a varied width forming a link lateral thickness transition, and a varied gradient forming a slope gradient transition. The link lateral thickness transition defines a first stress concentration location, and the slope gradient transition defines a second stress concentration location and is spaced from the link lateral thickness transition.

In still another aspect, a track link assembly includes a plurality of track links coupled together end-to-end to form a track chain and including a master link having a first half link and a second half link. The first half link includes a first clamping surface having a first tooth set, and the second half link includes a second clamping surface having a second tooth set. The first clamping surface further includes a descending slope extending between the first tooth set and a first vertically-facing link surface, and an ascending slope extending between the first tooth set and a second vertically-facing link surface. The first clamping surface further includes a link lateral width transition, and a slope gradient transition spaced from the link lateral width transition.

### BRIEF DESCRIPTION OF DRAWINGS

FIG. 1 is a side diagrammatic view of a machine, according to one embodiment;

FIG. 2 is a side diagrammatic view of a master link, according to one embodiment;

FIG. 3 is a side diagrammatic view of a half link for a master link, according to one embodiment;

FIG. 4 is a perspective view of a half link as in FIG. 3;

FIG. 5 is another perspective view of a half link as in FIG. 3; and

FIG. 6 is a side diagrammatic view of a portion of a master link, according to one embodiment.

### DETAILED DESCRIPTION

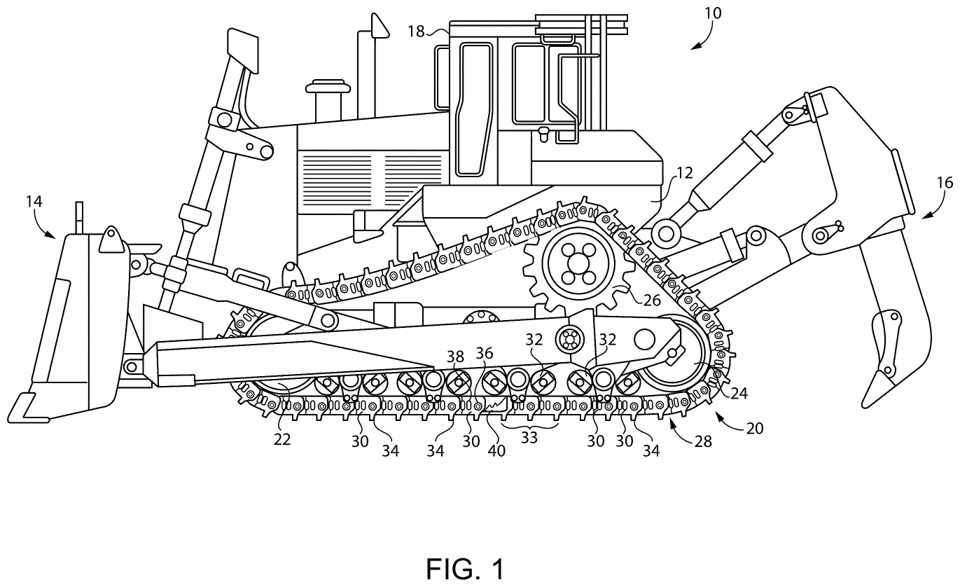

Referring to FIG. 1, there is shown a machine 10 according to one embodiment. Machine 10 is shown in the context of a track-type tractor having a machine frame 12, a front implement system 14 and a back implement system 16 both coupled to machine frame 12. An operator cab 18 is also supported on machine frame 12. Machine 10 also includes a ground-engaging track system 20. Track system 20 may include a front idler 22, a back idler 24, and a drive sprocket 26. Drive sprocket 26 is shown in a so-called “high drive” arrangement and is rotatable to advance an endless track 28 in forward and reverse directions to move machine 10 over a substrate. In other embodiments track 28 could have an oval configuration with one idler and one drive sprocket, for example. It will be appreciated that components of track system 20 shown in FIG. 1 may be substantially identical to other track system components on an opposite side of machine 10 and hidden from view in FIG. 1. While a track-type tractor presents a practical implementation of the present disclosure, in other embodiments a track-type machine such as a track loader or even a half-track machine might be equipped with a track system as contemplated herein. In still other instances, components of track system 20 could be employed in a track conveyance system or the like without limitation. Track system 20 may include a plurality of track rollers 32 that support a majority of a weight of machine 10 and roll along track rails formed by rail surfaces of track links 30 and master link 40.

Track 28 includes a plurality of track links 30 coupled end-to-end to form a track chain. Track shoes 34 may be attached to track links 30. Track links 30 may be coupled together by a plurality of track pins 36 and a plurality of track bushings 38. It should also be appreciated that track links 30 shown in FIG. 1 may comprise one chain of track links coupled via track pins 36 and track bushings 38 to a parallel track chain hidden from view. A plurality of track links coupled together may form a track link assembly 33 including at least one master link 40. As will be familiar to those skilled in the art, a master link may be used to selectively break and reconnect track links in a track chain for assembly, disassembly, servicing, etc. As track-type tractors and other track-type machines can operate in extremely rugged off-highway environments, field failures and/or performance degradation of track system components including master links can sometimes be observed, and are highly undesirable. As will be further apparent from the following description, master link 40 is uniquely configured for improved service and resistance to cracking, breakage, and other forms of damage.

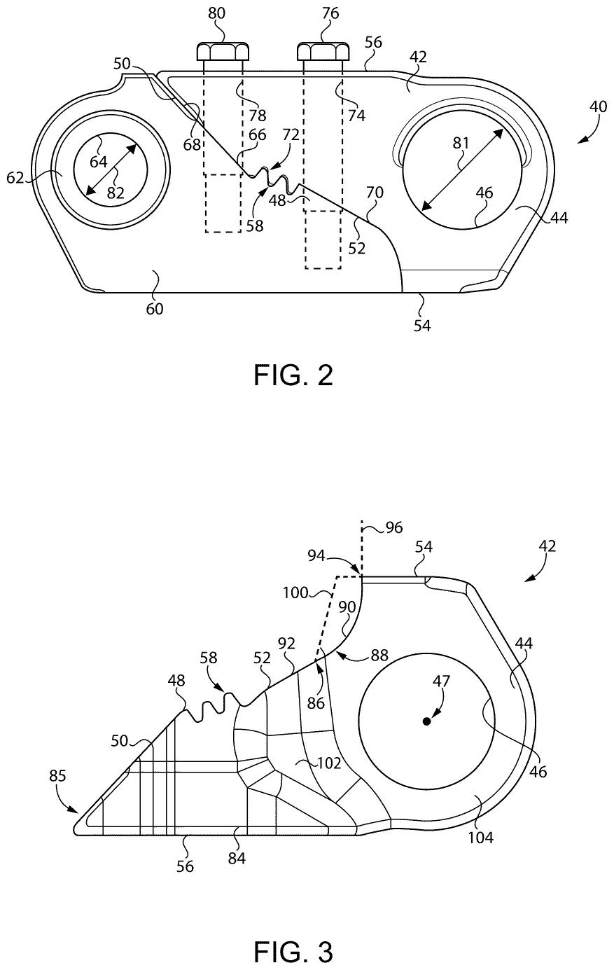

Referring also now to FIG. 2, master link 40 includes a first half link 42 having a first link strap 44. First link strap 44 includes a first inboard-outboard bore 46 formed therein. First half link 42 further includes a first clamping surface 48 having a descending slope 50, an ascending slope 52 extending to a vertically-facing link surface 54, and a first tooth set 58. Descending slope 50 may extend to a second vertically-facing link surface 56. In the illustrated embodiment, vertically-facing link surface 54 includes a rail surface and vertically-facing link surface 56 includes a shoe-side link surface. First tooth set 58 is spaced fore-aft from first inboard-outboard bore 46 and arranged between descending slope 50 and ascending slope 52.

Master link 40 further includes a second half link 60 including a second link strap 62 having a second inboard-outboard bore 64 formed therein, and a second clamping surface 66 shaped complementary to first clamping surface 48. Second clamping surface 66 also includes a descending slope 68, an ascending slope 70, and a second tooth set 72. When first half link 42 and second half link 60 are coupled together first tooth set 58 and second tooth set 72 interlock with one another. As can also be seen from FIG. 2, a first bolt hole 74 receiving a first bolt 76 may extend through ascending slope 52 and second clamping surface 66, and a second bolt hole 78 receiving a second bolt 80 may extend through descending slope 50 and second clamping surface 66. First bolt 76 and second bolt 80 may have unequal lengths as shown in the illustrated embodiment, and are typically configured to capture a track shoe against master link 40. It should also be appreciated the terms “ascending” and “descending” are used herein in a relative sense, and for ease of description. Ascending slope 52 ascends toward vertically-facing link surface 54, and descending slope 50 descends toward vertically-facing link surface 56. Depending upon perspective, the terms ascending and descending could be reversed in usage. Analogously, references herein to a “first” half link and a “second” half link should not be understood to require features and functionality of a half link are limited to one or the other of two half link. For instance, the geometries of first clamping surface 48 and second clamping surface 66 could be reversed relative to the illustrations in the attached drawings.

It can also be noted from FIG. 2 that first inboard-outboard bore 46 defines a first inner diameter dimension 81, and second inboard-outboard bore 64 defines a second inner diameter dimension 82. In the illustrated embodiment, first inner diameter dimension 81 is a larger inner diameter dimension so as to receive a track bushing, and second inner diameter dimension 82 is a smaller inner diameter dimension so as to receive a track pin. In other embodiments, the described and illustrated arrangement could be reversed with a track pin received in first half link 42 and a track bushing received in second half link 60.

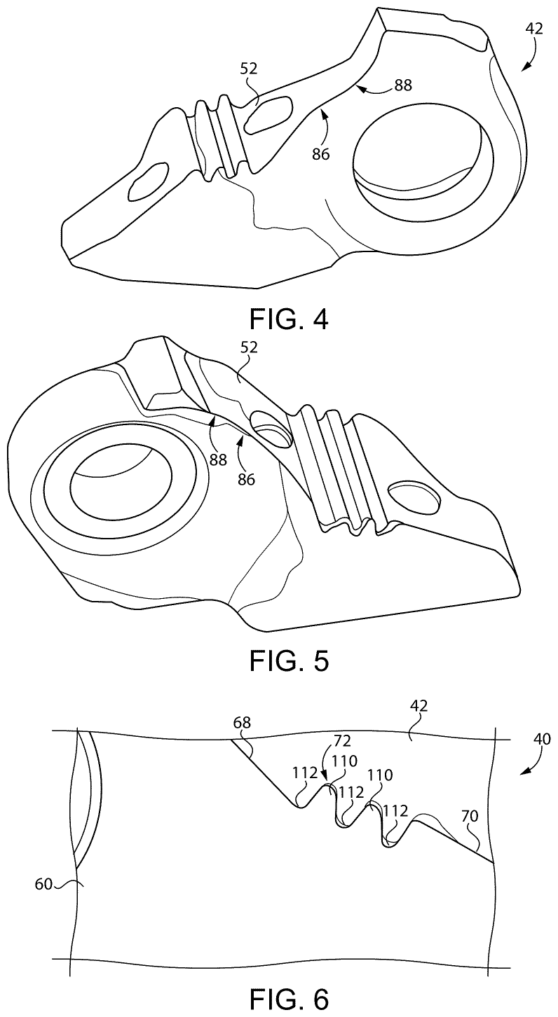

Referring also now to FIG. 3-5, there are shown views of first half link 42 and illustrating and identifying certain features in further detail. First half link 42 includes a link body 84 including vertically-facing link or shoe-side surface 56, and vertically-facing link or rail surface 54 opposite to vertically facing shoe-side surface 56. Clamping surface 48 extends vertically between shoe-side surface 56 and rail surface 54 and fore-aft between a link body end 85 and link strap 44. As discussed above, clamping surface 48 includes descending slope 50 and ascending slope 52. As can be seen from the drawings, ascending slope 52 has a varied width and also a varied slope gradient. The varied width of ascending slope 52 forms a link lateral thickness transition 86, and the varied gradient forms a slope gradient transition 88. Each of link lateral thickness transition 86 and slope gradient transition 88 may include a curved transition.

It has been discovered that a relatively abrupt change in thickness of a master link half link may be associated with certain stress concentrations during service, thus link lateral thickness transition 86 defines a first stress concentration location. It has also been observed that a relatively abrupt change in slope of a surface may be associated with certain stress concentrations during service, thus slope gradient transition 88 defines a second stress concentration location.

Focusing on FIG. 3, there is shown a dashed line profile 100 illustrating a contour of an example known half link design in comparison to the solid line profile illustrating an example half link design of the present disclosure. In the known half link design, a relatively linear and steep slope advances vertically upward and forwardly from link lateral thickness transition 86. In the known half link design, a link lateral thickness transition and a slope gradient transition were substantially at the same location, resulting in overlapping and potentially additive stress concentrations.

According to the present disclosure, slope gradient transition 88 is spaced from link lateral thickness transition 86. In the illustrated embodiment, slope gradient transition 88 is spaced fore-aft between link lateral thick transition 86 and a center axis 47 of first inboard-outboard bore 46. Also in the illustrated embodiment, it can be seen that slope gradient transition 88 is spaced both fore-aft and vertically from link lateral thickness transition 86, and more particularly still may be located rearward of inboard-outboard bore 46 in a direction of link body end 85.

Additional features of half link 42 as well as half link 60 can assist in de-concentrating stresses and prolonging service life. Still focusing on FIG. 3, it can be seen that ascending slope 52 includes an upper slope 90 extending curvilinearly between slope gradient transition 88 and vertically-facing link surface or rail surface 54. Ascending slope 52 also includes a lower slope 92. Link lateral thickness transition 86 may be within lower slope 92 in some embodiments. Slope gradient transition 88 may thus connect between linearly extending lower slope 92 and curvilinearly extending upper slope 90. Upper slope 90 may intersect vertically-facing link surface or rail surface 54 at an intersection 94. A line 96 tangent to upper slope 90 at intersection 94 may be oriented normal to vertically-facing link surface or rail surface 54. Upper slope 90 may define a parabolic profile approximately as illustrated in some embodiments.

It will further be apparent from the drawings that half link 42 narrows in thickness in a direction of link strap 44. It can also be observed that a gradient of ascending slope 52 steepens in a vertically upward direction. Link lateral thickness transition 86 may thus include a narrowing transition in a forward direction of link strap 44, and in some embodiments can include a flattening transition as a lateral profile of half link 42 flattens toward first inboard-outboard bore 46. Link lateral thickness transition 86 may connect between a link side surface 102 and a strap lateral surface 104 that extends planarly around first inboard-outboard bore 46. Thus, in the illustrated embodiment link lateral thickness transition 86 includes a flattening transition, and slope gradient transition 88 includes a steepening transition. In other embodiments different forms of transitions could be present in a clamping face of a half link and separated and spaced to limit stress concentrations.

Referring also now to FIG. 6, there are shown additional features of master link 40, including upon second half link 60. It will be recalled second half link 60 includes a descending slope 68 and an ascending slope 70. Second tooth set 72, and by way of analogy first tooth set 58, may include a plurality of teeth 110 alternating with a plurality of tooth roots 112. In a practical implementation, each of first tooth set 58 and second tooth set 72 may include a total of three full teeth, or less, between the respective ascending and descending slopes, and confined in distribution between first bolt hole 74 and second bolt hole 78. It can also be noted from FIG. 6 that second tooth set 72 includes a leading tooth root 112, leftmost in the illustration, defined by a leading tooth 110, also leftmost in the illustration, and by the respective descending slope 68. The leading tooth root 112 may define a concave profile and the respective descending slope may define a linear profile directly connected to the concave profile.

### INDUSTRIAL APPLICABILITY

Referring to the drawings generally, when machine 10 including track system 20 is placed in service track 28 can be advanced around the various rotatable elements, and support the weight of machine 10 upon a substrate. In virtually any operating environment track 28 can routinely encounter obstacles such as rocks or other debris, and otherwise slippery, uneven, and steep underfoot conditions. As a result, individual track links within track 28 can be subjected to a variety of loads, including side loads, bending loads, twisting loads, impacts and still others. As alluded to above, certain known master link designs included overlapping transitions at locations of varied width, height, gradient, etc. Due to the overlapping stress concentration locations a track system could at least occasionally experience compound loads which together overcome the strength of the half link materials, leading to cracking, failure, or other problems. According to the present disclosure stress concentration locations are separated, and a master link provided that is better capable of managing such conditions.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims. As used herein, the articles “a” and “an” are intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A master link for a track comprising:
a first half link including a first link strap having a first inboard-outboard bore formed therein, a first clamping surface including a descending slope, an ascending slope extending to a vertically-facing link surface, and a first tooth set spaced fore-aft from the first inboard-outboard bore and arranged between the descending slope and the ascending slope;
the ascending slope including a link lateral thickness transition, and a slope gradient transition;
the slope gradient transition is spaced fore-aft between the link lateral thickness transition and a center axis of the first inboard-outboard bore; and
a second half link including a second link strap having a second inboard-outboard bore formed therein, and a second clamping surface shaped complementary to the first clamping surface.

2. The master link of claim 1 wherein:
a first bolt hole extends through the ascending slope and the second clamping surface, and a second bolt hole extends through the descending slope and the second clamping surface; and
the first tooth set includes a total of three full teeth or less confined in distribution between the first bolt hole and the second bolt hole.

3. The master link of claim 2 wherein:
the vertically-facing link surface includes a track rail surface facing a first vertical direction, and the descending slope extends to a shoe-side surface facing a second vertical direction; and
the first inboard-outboard bore includes a bushing bore defining a larger inner diameter dimension, and the second inboard-outboard bore includes a pin bore defining a smaller inner diameter dimension.

4. The master link of claim 1 wherein the slope gradient transition connects between a linearly extending lower slope, and a curvilinearly extending upper slope.

5. The master link of claim 4 wherein the upper slope intersects the vertically-facing link surface at an intersection, and a line tangent to the upper slope at the intersection is oriented normal to the vertically-facing link surface.

6. The master link of claim 4 wherein the upper slope defines a parabolic profile.

7. The master link of claim 1 wherein the link lateral thickness transition connects between a link lateral surface, and a strap lateral surface extending planarly around the first inboard-outboard bore.

8. The master link of claim 1 wherein the slope gradient transition is located rearward of the first inboard-outboard bore.

9. The master link of claim 1 wherein the second clamping surface includes a descending slope and an ascending slope, and the second tooth set includes a leading tooth root defined by a leading tooth and the respective descending slope.

10. The master link of claim 9 wherein the leading tooth root defines a concave profile and the respective descending slope defines a linear profile directly connected to the concave profile.

11. A half link for a master link comprising:
a link body including a shoe-side surface and a rail surface opposite the shoe-side surface, a clamping surface extending vertically between the shoe-side surface and the rail surface and fore-aft between a link body end and a link strap having an inboard-outboard bore formed therein;
the clamping surface including a descending slope, an ascending slope, and a tooth set arranged between the descending slope and the ascending slope;
the ascending slope having a varied width forming a link lateral thickness transition, and a varied gradient forming a slope gradient transition; and
the link lateral thickness transition defines a first stress concentration location, and the slope gradient transition defines a second stress concentration location and is spaced from the link lateral thickness transition.

12. The half link of claim 11 wherein the slope gradient transition is spaced both fore-aft and vertically from the link lateral thickness transition.

13. The half link of claim 12 wherein the slope gradient transition is located rearward of the inboard-outboard bore.

14. The half link of claim 11 wherein the ascending slope includes an upper slope extending curvilinearly between the slope gradient transition and the rail surface, and a lower slope.

15. The half link of claim 12 wherein the link lateral thickness transition is within the lower slope and includes a flattening transition, and the slope gradient transition includes a steepening transition.

16. The half link of claim 11 wherein the tooth set includes a total of three full teeth or less.

17. A track link assembly comprising:
a plurality of track links coupled together end-to-end to form a track chain and including a master link having a first half link and a second half link;
the first half link including a first clamping surface having a first tooth set, and the second half link including a second clamping surface having a second tooth set;
the first clamping surface further including a descending slope extending between the first tooth set and a first vertically-facing link surface, and an ascending slope extending between the first tooth set and a second vertically-facing link surface; and
the first clamping surface further including a link lateral width transition, and a slope gradient transition spaced from the link lateral width transition.

18. The track link assembly of claim 17 wherein the ascending slope includes a linearly extending lower slope between the first tooth set and the slope gradient transition, and an upper slope, and the link lateral thickness transition is within the linearly extending lower slope.

19. The track link assembly of claim 18 wherein the upper slope includes a curvilinearly extending upper slope, and the slope gradient transition connects between the linearly extending lower slope and the curvilinearly extending upper slope.

20. The track link assembly of claim 17 wherein the second clamping surface includes a descending slope and an ascending slope, and the second tooth set includes a total of three full teeth or less including a leading tooth, and a leading tooth root defined between the leading tooth and the respective descending slope, and wherein the leading tooth root defines a concave profile and the respective descending slope defines a linear profile directly connected to the concave profile.
